(19) United States
(12) Patent Application Publication
(10) Pub. No.: US 2005/0078625 A1
(43) Pub. Date: Apr. 14, 2005

(54) Wireless network system and a method of registering a station

(75) Inventors: Chee-hwan Yang, Suwon-si (KR); Youne-sang Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/949,384

(22) Filed: Sep. 27, 2004

(30) Foreign Application Priority Data
Oct. 9, 2003 (KR) 2003-70234

(51) Int. Cl. H04L 12/28

(52) U.S. Cl. 370/328; 370/338

(57) ABSTRACT

A wireless network system including a station, a plurality of access points to which the station is accessible, an access speed detector provided to each access point to detect access speed of a station registered to the access point, and a network controller provided to the station, to receive information in relation to the access speed from the access point and to control the station to be registered to the access point that provides optimum access speed based on the received information in relation to the access speed. Accordingly, the present invention provides a wireless network system and a method of registering a station in which the station is registered to an access point that provides optimum access speed and/or optimum signal intensity among a plurality of accessible access points, to thereby improve network efficiency.

### CROSS-REFERENCE TO RELATED APPLICATIONS

This application claims the benefit of Korean Patent Application No. 2003-70234, filed Oct. 9, 2003, in the Korean Intellectual Property Office, the disclosure of which is incorporated herein by reference.

### BACKGROUND OF THE INVENTION

1. Field of the Invention

The present invention relates to a wireless network, more particularly, to a wireless network system and a method of registering a station according to which the station is registered to an access point that provides optimum access speed and/or optimum signal intensity among a plurality of accessible access points to thereby improve network efficiency.

2. Description of the Related Art

Recently, popularity of portable computers such as laptop computers, personal digital assistants (PDA), tablet computers, etc. has been on the rise because of their convenience. Further, as wireless network technology such as a wireless local area network (LAN) is developed, portable computers are able to receive various information and services through a network while mobile. The wireless LAN is one of wireless network systems in which a plurality of computers are connected through a network in a local area and communicate with each other using numerous data bits per second.

Generally, the wireless network system comprises: a computer provided with a station for the wireless network, and an access point (AP) connected to a wired network to allow the station to be connected to the wired network. Accordingly, the AP has an inherent service area and wirelessly communicates with the station located in the service area.

Further, when a station is accessible to a plurality of access points, according to the conventional station, the station is registered to the AP where signal intensity is the strongest. Referring to FIG. 1, for example, there are three access points AP1, AP2 and AP3, the service areas of the respective access points AP1, AP2 and AP3 are partially overlapped, and the stations ST1, ST2, ST3, ST4 and ST5 are located in the service area of the access point AP1, which is enclosed by a solid line in FIG. 1 and indicates an area where the signal intensity is relatively strong. At the same time, stations ST3 and ST5 are located in the service area of access point AP2, which is enclosed by a broken line that surrounds AP2, and indicates an area where the signal intensity is relatively weak. Further, stations ST4 and ST5 are located in the service area of access point AP3, which is enclosed by the broken line that surrounds AP3, and indicates an area where the signal intensity is relatively weak. In this case, stations ST1 through ST5 are registered to access point AP1 which has the strongest signal intensity among all the access points AP1, AP2 and AP3, thus, the stations communicate with access point AP1.

However, because according to the conventional wireless network system, station ST5 is registered to access point AP1 which has the strongest signal intensity among all accessible access points AP1, AP2 and AP3 even though stations ST1 through ST4 are also all registered to and communicate with the access points AP1, a signal bottleneck is created at access point AP1, thereby decreasing network efficiency of the entire wireless network system. For example, in a case where each of the access points AP1 through AP3 has a maximum throughput of 5 Mbps, the entire wireless network system has the maximum throughput of 15 Mbps. In this case, because stations ST1 through ST5 are all registered to the access point AP1, each of the stations ST1 through ST5 has the allowable throughput of 1 Mbps. Thus, transfer speed, access speed, etc. between each of the stations ST1 through ST5 and the access points AP1, AP2 or AP3 is remarkably decreased. Further, even though station ST5 is located in the strong signal intensity service area of access point AP1, station ST5 may get faster transfer speed, faster access speed, etc. when station ST5 accesses access point AP2 that provides the relatively weak signal intensity rather than through access point AP1 that provides the relatively strong signal intensity. Therefore, the station registering method of the conventional wireless network system decreases the network efficiency.

### SUMMARY OF THE INVENTION

Accordingly, it is an aspect of the present invention to provide a wireless network system and a method of registering a station according to which the station is registered to an access point that provides optimum access speed and/or optimum signal intensity among a plurality of accessible access points, to thereby improve network efficiency.

The foregoing and/or other aspects of the present invention are achieved by providing a wireless network system comprising: a station; a plurality of access points to which the station is accessible; an access speed detector provided to each of the plurality of access points to detect access speed of each station registered to the respective access point; and a network controller provided to the station to receive information in relation to the access speed from the plurality of access points and, to control the station to be registered to at least one of the plurality of access points that provides optimum access speed based on the received information related to the access speed.

Additional aspects and advantages of the invention will be set forth in part in the description which follows and, in part, will be obvious from the description, or may be learned by practice of the invention.

According to an aspect of the invention, a plurality of stations are registered and the information in relation to the access speed comprises information related to average access speed of the registered stations.

According to another aspect of the invention, the access speed detector calculates the average access speed of the registered stations at predetermined intervals.

According to an aspect of the invention, the access point embeds the information in relation to the access speed detected via the access speed detector in a beacon signal and transmits the beacon signal to the station.

According to yet another aspect of the invention, when the plurality of access points provide the optimum access speed, the network controller determines signal intensities of the respective access points that provide the optimum access speed, and controls the station to be registered to at least one access point that provides optimum signal intensity.

Further, according to an aspect of the invention, the network controller receives information in relation to the access speed at predetermined intervals, and controls a new station to be registered to at least one access point that provides optimum access speed based on the newly received information in relation to the access speed.

According to another aspect of the present invention, the above and/or other advantages are achieved by providing a wireless network system comprising: a station; a plurality of access points to which the station is accessible; an access speed detector provided to each access point to detect access speed of each station registered to the plurality of access points; and a network controller provided to the station to receive information in relation to the access speed from the respective access points, to determine signal intensity of each of the plurality of access points to control a station to be registered to at least one of the plurality of access points that provides an optimum access state based on the received information in relation to the access speed and the determined signal intensity.

According to an aspect of the invention, a plurality of stations are registered and the information in relation to the access speed includes information in relation to average access speed of the registered stations.

According to an aspect of the invention, the access speed detector calculates the average access speed of the registered stations at predetermined intervals.

According to an aspect of the invention, the access point embeds the information in relation to the access speed detected via the access speed detector in a beacon signal, and transmits the beacon signal to the station.

According to another aspect of the invention, the network controller receives new information in relation to the access speed at predetermined intervals, determines the signal intensities of the respective access points at predetermined intervals, and controls a new station to be registered to the access point that provides an optimum access state based on the newly received information in relation to the access speed and based on the newly determined signal intensity.

Further, according to another aspect of the present invention, the above and/or other advantages are achieved by providing a method of registering a station in a wireless network system having a station and a plurality of access points to which the station is accessible. The method comprises: detecting access speed of each station registered to the plurality of access points; transmitting information in relation to the detected access speed from each access point; receiving the information in relation to the access speed in the station; and registering the station to the access point that provides optimum access speed based on the received information in relation to the access speed.

According to an aspect of the invention, the information in relation to the access speed includes information in relation to average access speed of each registered station.

According to an aspect of the invention, the transmission of the information in relation to the detected access speed from each access point includes embedding the information in relation to the detected access speed in a beacon signal.

According to an aspect of the invention, the method further comprises: determining signal intensities of the respective access points that provide the optimum access speed when the plurality of access points provide the optimum access speed, wherein the registering of the station comprises registering the station to the access point that provides optimum signal intensity.

According to an aspect of the invention, the method further comprises: receiving new information in relation to the access speed of the station; and registering a new station to the access point that provides the optimum access speed based on the newly received information in relation to the access speed.

According to another aspect of the present invention, the above and/or other advantages may also be achieved by providing a method of registering a station in a wireless network system having the station and a plurality of access points to which the station is accessible. The method comprises: detecting access speed of each station registered to the plurality of access points; transmitting information in relation to the detected access speed from the plurality of access points; receiving the information in relation to the access speed of the station; detecting signal intensity of each access point; and registering the station to the access point that provides optimum access state based on the received information in relation to the access speed and the determined signal intensity.

According to another aspect of the invention, the information in relation to the access speed includes information in relation to average access speed of the registered stations.

Moreover, according to an aspect of the invention, the transmission of the information in relation to the detected access speed from each access point includes embedding the information in relation to the detected access speed in a beacon signal.

According to another aspect of the invention, the method further comprises: receiving new information in relation to the access speed; re-determining signal intensities of the respective access points; and registering a station to the access point that provides the optimum access state based on the newly received information in relation to the access speed and the newly determined signal intensity.

### BRIEF DESCRIPTION OF THE DRAWINGS

These and/or other aspects and advantages of the invention will become apparent, and more readily appreciated from the following description of the preferred embodiments, taken in conjunction with the accompany drawings of which:

FIG. 1 illustrates a plurality of stations located in a service area of an access point;

FIG. 2 illustrates a wireless network system according to an aspect of the present invention;

FIG. 3 is a control block diagram of an access point and stations according to an aspect of the present invention;

FIG. 4 is a control flow chart of a wireless network system according to an aspect of the present invention; and

FIG. 5 is a control flow chart of a wireless network system according to another aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

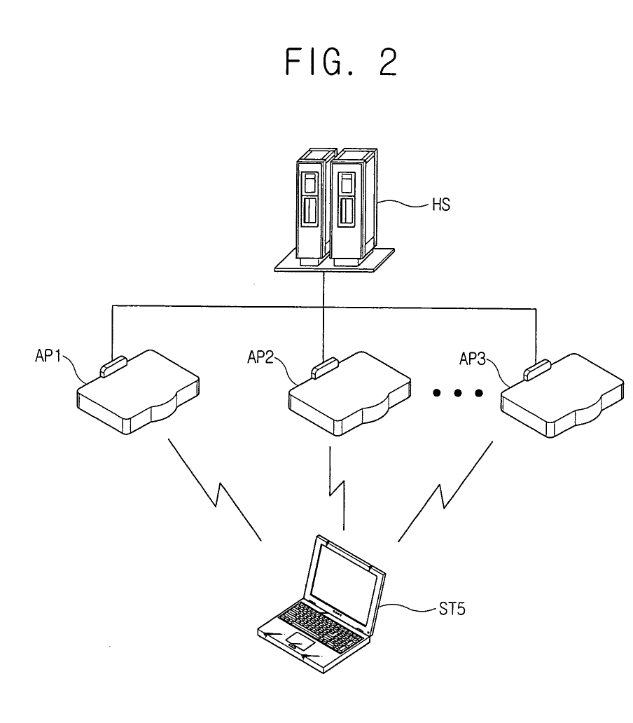

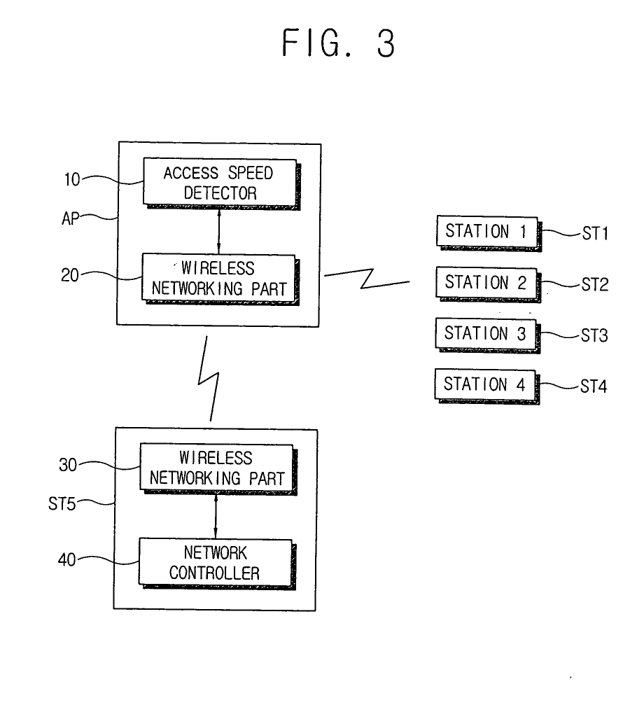

Referring to FIGS. 2 and 3, a wireless network system according to an aspect of the present invention comprises: a station ST, and a plurality of access points AP to which the station ST is accessible.

The access point AP is connected to a host HS through a wired network and communicates with the host HS. The access point AP receives data from the host HS and transmits the data to the station ST, which is registered to the access point, through a wireless networking part 20. Further, the access point AP receives data from the station ST through the wireless networking part 20, and transmits the data to the host HS. That is, the access point AP wirelessly communicates with the station ST, and thereby allows the station ST to communicate with the wired network.

Further, the access point AP according to an aspect of the present invention comprises: an access speed detector 10 to detect an access speed of the registered station ST. According to an aspect of the present invention, the access speed detector 10 detects the access speed of the registered station ST at predetermined intervals, and stores information in relation to the detected access speed in a memory (not shown). Further, in a case where there are at least two registered stations ST, the respective access speeds of the stations ST are detected and averaged into an average access speed.

The access point AP periodically transmits the information in relation to the detected access speed (or the average access speed, hereinafter the same) through the wireless networking part 20. According to an aspect of the invention, the access point AP embeds the information in relation to the access speed detected by the access speed detector 10 in a beacon signal, and transmits the information through the wireless networking part 20. Further, it should be appreciated that the access point AP transmits the information in relation to the access speed to the station ST when the station ST requests the information in relation to the access speed. Thus, the station ST receives the beacon signal from the access point AP and is therefore selectively registered to the access point AP based on the information in relation to the access speed or the average access speed embedded in the beacon signal.

The station ST according to another aspect of the present invention comprises: a wireless networking part 30 to wirelessly communicate with the access point AP, and a controller 40 to control the wireless networking part 30.

The network controller 40 controls the station ST to be registered to the access point AP that provides an optimum access speed based on the information in relation to the access speeds received from the access points AP through the wireless network part 30. According to an aspect of the invention, the access point AP that provides the optimum access speed is the access point AP that provides the fastest access speed.

Further, when the plurality of access points AP can provide the optimum access speed, the network controller 40 controls the station ST to be registered to the access point AP that provides optimum signal intensity among the plurality of access points AP that provide the optimum access speed. That is, the network controller 40 determines signal intensities of the respective access points AP that provide the optimum access speed, and controls the station ST to be registered to the access point AP that provides the strongest signal intensity. Accordingly, the case that the plurality of access points AP can provide the optimum access speed is when the plurality of access points AP can provide the fastest access speed or the access speed within a predetermined limit.

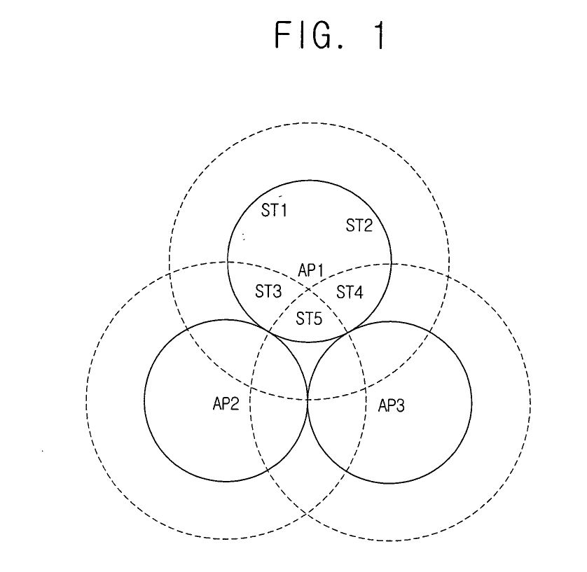

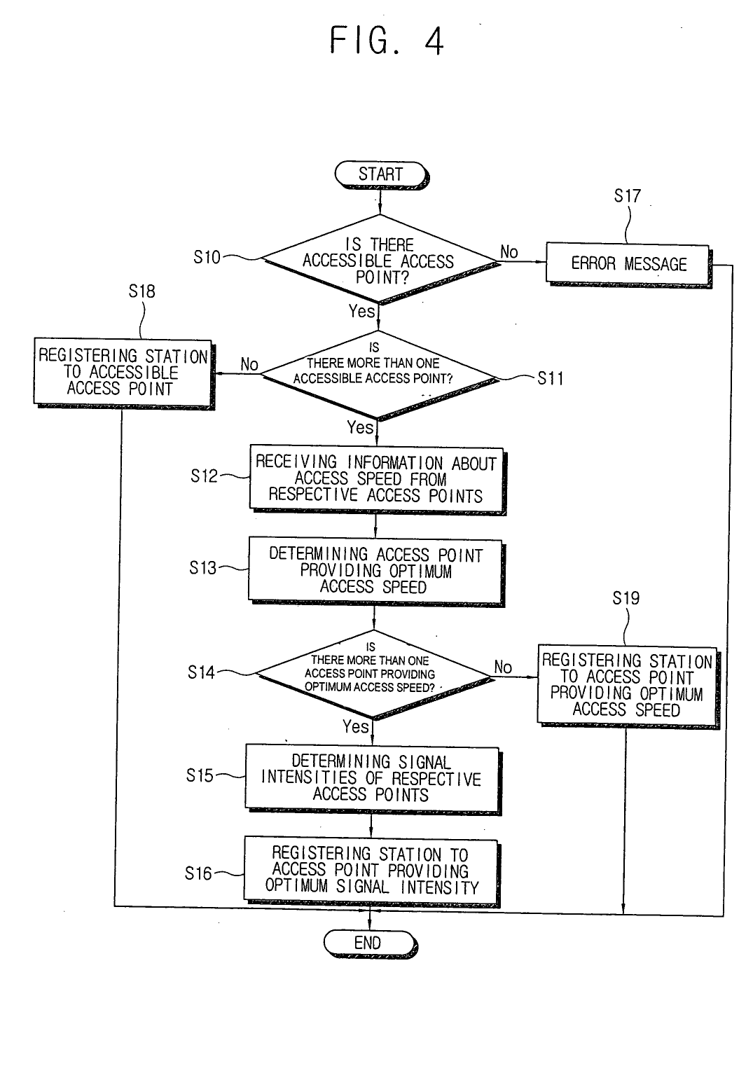

Hereinbelow, in the wireless network system according to an aspect of the present invention, a method of registering the station ST will be described with reference to FIG. 4. Referring to FIGS. 1 and 2, suppose that the stations ST1 through ST4 were registered to the access point AP1, and the station ST5 needs to be registered.

For example, in the case of the access point AP1, the access speed detector 10 of the access point AP1 checks an access state of the registered stations ST1, ST2, ST3 and ST4 and detects the access speeds of the respective stations ST1 through ST4. Further, the access speed detector 10 calculates the average access speed based on the detected access speeds of the respective stations ST1, ST2, ST3 and ST4. Then, the information in relation to the calculated average access speed is stored in the memory. Then, the access point AP1 periodically transmits the beacon signal that contains the information in relation to the calculated average access speed. Similarly, when there are stations ST registered to the access points AP2 and/or AP3, the access point AP2 and/or AP3 check the access speed of the station registered thereto, and periodically transmit the information in relation to the detected access speed embedded in the beacon signal.

Meanwhile, when the station ST5 is registered to the access point AP, at operation S10, the network controller 40 of the station ST5 checks whether there is an accessible access point AP. Here, the network controller 40 checks the accessible access points AP by receiving the beacon signals periodically transmitted from the access points AP. When there is no accessible access point AP, at operation S17, the network controller 40 gives an error message (or continuously checks whether the accessible access points AP exist until there is an input by a user).

When there is accessible access points AP, at operation S11, the network controller 40 determines how many accessible access points AP exist. In a case where there is only one accessible access point AP, at operation S18, the network controller 40 controls the station ST5 to be registered to the one accessible access point AP. In a case where there is a plurality of accessible access points AP, the network controller 40, at operation S12, receives the information in relation to the access speeds from the respective access points AP, and, at operation S13, determines the access point AP that provides the optimum access speed.

Then, the network controller 40 controls the station ST5 to be registered to the accessible access point AP that provides the optimum access speed, for example, access point AP2.

At this time, at operation S14, the network controller 40 determines how many accessible access points AP can provide the optimum access speed. In a case where a plurality of accessible access points AP can provide the optimum access speed, the network controller 40, at operation S15, determines the signal intensities of the respective accessible access points AP. Then, at operation S16, the network controller 40 controls the station ST5 to be registered to the accessible access point AP that provides the optimum signal intensity based on the determined signal intensities. In a case where only one accessible access point AP can provide the optimum access speed, at operation S19, the network controller 40 controls the station ST5 to be registered to the one accessible access point AP that provides the optimum signal intensity.

Further, in a wireless network system according to another aspect of the present invention, a network controller 40 receives the information in relation to the access speeds from the access points AP and determines the signal intensities of the respective access point AP, and thereby controls the station ST5 to be registered to the access point AP that provides an optimum access state based on the information in relation to the detected access speed and the determined signal intensity.

For example, let the access speed and the signal intensity of the access point AP be “TP” and “STR”, respectively. At this time, the access point AP that provides the optimum access state can be determined by the following equation 1.
access state=a×STR+b×TP

where “a” and “b” are proportional constants related to the signal intensity and the access speed, respectively. Further, according to an aspect of the present invention, the proportional constants “a” and “b” are determined to give relative importance to the access speed when the access point AP that provides the optimum access state is determined.

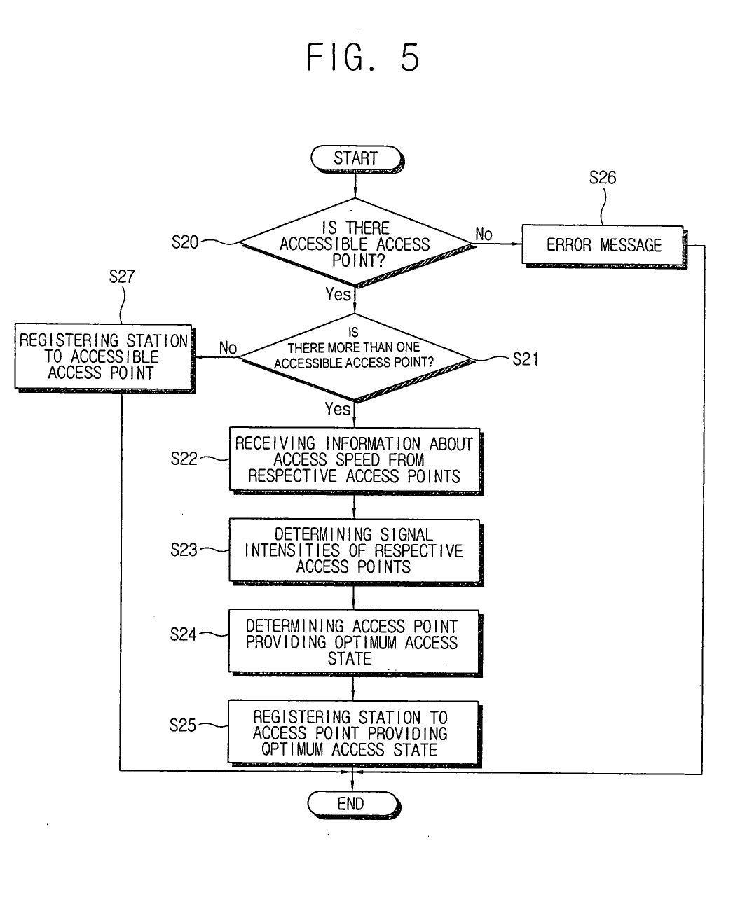

FIG. 5 is a control flow chart of an operation to register a station in a wireless network system according to another aspect of the present invention. As shown, at operation S20, the network controller 40 of the station ST5 checks whether there is an accessible access point AP. When it is determined that there is no accessible access point AP, at operation S26, the network controller 40 gives an error message.

When there are accessible access points AP, at operation S21, the network controller 40 determines how many accessible access points AP are checked. In a case where there is only one accessible access point AP, at operation S27, the network controller 40 controls the station ST5 to be registered to the one accessible access point AP. In a case where there is the plurality of accessible access points AP, the network controller 40, at operation S22, receives the information in relation to the access speeds from the respective access points AP, and, at operation S23, determines the signal intensities of the respective access points AP. Then, the network controller 40, at operation S24, determines the access point AP that provides the optimum access state by using the equation 1, and, at operation S25, controls the station ST5 to be registered to the access point AP that provides the optimum access state.

On the other hand, the network controller 40 of the station ST according to another aspect of the invention may check the access speed and/or the signal intensity at predetermined intervals and control the station ST to be newly registered to the access point AP that provides the optimum access state. That is, the network controller 40 according to an aspect can receive new information in relation to the access speed at predetermined intervals and control the station ST to be newly registered to the access point AP to provide the optimum access speed based on the newly received information in relation to the access speed. Further, the network controller 40 according to another aspect of the invention can receive new information in relation to the access speed at predetermined intervals, re-determine the signal intensities of the respective access points AP at predetermined intervals, and control the station ST to be newly registered to the access point AP that provides the optimum access state based on the newly received information in relation to the access speed and the newly determined signal intensity.

Further, the access speed detector 10 may use a throughput between the access point AP and the registered station ST as the access speed.

Thus, the wireless network system according to an aspect of the present invention comprises: the access speed detector 10 provided to the access point AP to detect the access speed of the station ST registered to the access point, and the network controller 40 provided to the station ST, to receive the information in relation to the access speed from the access point AP and control the station ST to be registered to the access point AP that provides the optimum access speed based on the received information in relation to the access speed, so that the station ST is registered to the access point that provides the optimum access speed and/or the optimum signal intensity, and thereby improve the network efficiency.

As described above, the present invention provides a wireless network system and a method of registering a station according to which the station is registered to an access point that provides optimum access speed and/or optimum signal intensity among a plurality of accessible access points, and thereby improve network efficiency.

Although a few embodiments of the present invention have been shown and described, it would be appreciated by those skilled in the art that changes may be made in these embodiments without departing from the principles and spirit of the invention, the scope of which is defined in the claims and their equivalents.

1. A wireless network system having a station and a plurality of access points to which other stations are registered and the station is accessible, comprising:
access speed detectors respectively provided to each of the plurality of access points, each access speed detector to detect access speed of the other stations registered to the access point; and
a network controller provided to the station, to receive information in relation to the access speed from the access points, to control the station to be registered to one of the plurality of access points that provides optimum access speed based on the received information in relation to the access speed.

2. The wireless network system according to claim 1, wherein the information in relation to the access speed includes information related to an average access speed of each registered station of the corresponding access points.

3. The wireless network system according to claim 2, wherein each access speed detector calculates the average access speed of each registered station of the corresponding access points at predetermined intervals.

4. The wireless network system according to claim 1, wherein the access points embed the information in relation to the access speed detected via the access speed detector of the corresponding access points in a beacon signal and transmit the beacon signal to the station.

5. The wireless network system according to claim 1, wherein when a number of the plurality of access points provide the optimum access speed, the network controller determines signal intensities of the respective access points that provide the optimum access speed, and controls the station to be registered to the one of the plurality of access points that provides optimum signal intensity.

6. The wireless network system according to claim 1, wherein the network controller receives new information in relation to the access speed at predetermined intervals, and controls the station to be registered to the access point that provides the optimum access speed based on the newly received information in relation to the access speed.

7. A wireless network system including a station and a plurality of access points to which other stations are registered and the station is accessible, comprising:
access speed detectors respectively provided to each of the plurality of access points, each access speed detector to detect access speed of the other stations registered to the access point; and
a network controller provided to the station, to receive information in relation to the access speed from the access points, to determine signal intensity of each of the plurality of access points, and control the station to be registered to one of the plurality of access points that provides an optimum access state based on the received information in relation to the access speed and the determined signal intensity.

8. The wireless network system according to claim 7, wherein the information in relation to the access speed includes information related to an average access speed of each registered station of the corresponding access points.

9. The wireless network system according to claim 8, wherein each access speed detector calculates the average access speed of each registered station of the corresponding access points at predetermined intervals.

10. The wireless network system according to claim 7, wherein the access points embed the information in relation to the access speed detected via the access speed detector of the corresponding access points in a beacon signal, and transmit the beacon signal to the station.

11. The wireless network system according to claim 7, wherein the network controller receives new information in relation to the access speed at predetermined intervals, determines the signal intensities of the respective access points at the predetermined intervals, and controls the station to be registered to the one of the plurality of access points that provides an optimum access state based on the newly received information in relation to the access speed and the newly determined signal intensity.

12. A method of registering a station in a wireless network system having the station and a plurality of access points to which the station is accessible, comprising:
detecting access speed of at least one station registered to each of the plurality of access points;
transmitting information in relation to the detected access speed from each of the plurality of access points;
receiving the information in relation to the access speed in the station; and
registering the station to one of the plurality of access points that provides optimum access speed based on the received information in relation to the access speed.

13. The method according to claim 12, wherein the information in relation to the access speed includes information in relation to an average access speed of the at least one registered station.

14. The method according to claim 12, wherein the transmission of the information in relation to the detected access speed from each of the plurality of access points comprises:
embedding the information in relation to the detected access speed in a beacon signal.

15. The method according to claim 12, further comprising:
determining signal intensities of respective access points that provide the optimum access speed when a number of the plurality of access points provide the optimum access speed, wherein the registering of the station includes registering the station to the one of the plurality of access points that provides optimum signal intensity.

16. The method according to claim 12, further comprising:
receiving new information in relation to the access speed in the station; and
registering the station to the one of the plurality of access points that provides optimum access speed based on the newly received information in relation to the access speed.

17. A method of registering a station in a wireless network system having the station and a plurality of access points to which the station is accessible, comprising:
detecting access speed of at least one station registered to the plurality of access points;
transmitting information in relation to the detected access speed from the plurality of access points;
receiving the information in relation to the access speed in the station;
determining signal intensity of each of the plurality of access points; and
registering the station to one of the plurality of access points that provides an optimum access state based on the received information in relation to the access speed and the determined signal intensity.

18. The method according to claim 17, wherein the information in relation to the access speed includes information in relation to an average access speed of the at least one registered station.

19. The method according to claim 17, wherein the transmission of the information in relation to the detected access speed from each of the plurality of access points comprises:
embedding the information in relation to the detected access speed in a beacon signal.

20. The method according to claim 17, further comprising:
receiving new information in relation to the access speed;
re-determining the signal intensities of each of the plurality of access points; and
registering the station to the access point that provides the optimum access state based on the newly received information in relation to the access speed and based on the newly determined signal intensity.

21. The wireless network system according to claim 1, wherein average access speed of the plurality of stations is detected via the respective access speed detectors of the plurality of access points, and the detected speeds are averaged into an average access speed.

22. The wireless network system according to claim 1, wherein the access speed detector provided to each access point stores the information in relation to the detected access speed.

23. The wireless network system according to claim 1, wherein the station further comprises:
a wireless networking part to wirelessly communicate with the plurality of access points; and
a controller to control the wireless networking part.

24. The wireless network system according to claim 1, wherein the plurality of access points periodically transmit the detected access speed to the station.

25. The wireless network system according to claim 24, wherein the plurality of access points transmit the detected access speed to the station upon receiving a request from the station.

26. A method of registering a station in a wireless network system having a plurality of access points, comprising:
receiving information in relation to access speed from the plurality of access points;
determining which of the plurality of access points provides an optimum access speed and an optimum signal intensity; and
registering a station to one of the plurality of access points that provides the optimum access speed and the optimum signal intensity.

27. The method according to claim 26, wherein the station is registered to one of the plurality of access points that satisfies a condition of:
access state=(a×STR)+(b×TP)
where, TP is access speed of the access point, STR is the signal intensity of the access point, and a and b are proportional constants related to the signal intensity and the access speed, respectively.
